(19) United States
(12) Patent Application Publication
(10) Pub. No.: US 2008/0307983 A1
(43) Pub. Date: Dec. 18, 2008

(54) Tire winder with tire flap lock

(75) Inventor: Douglas MacArthur Johnson, San Fidel, NM (US)

Correspondence Address: Douglas M. Johnson, P.O. Box 565, Sanfidel, NM, 87049, US

(73) Assignee: Mr. Douglas MacArthur Johnson, San Fidel, NM (US)

(21) Appl. No.: 12/151,002

(22) Filed: May 2, 2008

Related U.S. Application Data
(60) Provisional application No. 60/934,168, filed on Jun. 12, 2007.

(51) Int. Cl. B30B 9/00; B09B 5/00

(52) U.S. Cl. 100/78; 242/527; 100/97

(57) ABSTRACT

Two cuts are made in the tire. Cut #1 is anywhere on the tire and cuts through the tread stopping at the bead. Cut #2 is placed 3″ from Cut #1 and goes all the way through the tire cutting the bead creating the Tire Flap Lock, to be used to lock the tire in its final coiled shape. The tire is placed in a bin and the Tire Coiling Fork is pushed through the tire and begins coiling. The Tire Flap Lock is caught by the Tire Flap Prong and is held stationery while the tire continues to coil. As the tire completes its coiling the Tire Flap Lock is positioned around the tire so that when the Tire Coiling Fork is withdrawn the pressure for the tire to uncoil will be caught by the Tire Flap Lock thereby locking the tire in its new coiled shape as a Tire Building Block.

This application claims priority of provisional application No. 60/934,168 filed Jun. 12, 2007

### CROSS-REFERENCE TO RELATED APPLICATIONS

Not Applicable

### STATEMENT OF FEDERALLY SPONSORED RESEARCH/DEVELOPMENT

Not Applicable

### REFERENCE TO A SEQUENCE LISTING, A TABLE, OR A COMPUTER PROGRAM, LISTING COMPACT DISC APPENDIX

Not Applicable

### BACKGROUND OF THE INVENTION

With 300 million tires discarded each year in the U.S. there is obviously a disposal problem. To recycle in the fastest and cheapest way would be the goal and ideal in recycling tires, but that is not the case in some of the machines now working to recycle tires. Tire recycling machines are large, complicated, and expensive to manufacture and operate. Quite a few leave behind a by product such as the steel belts and the steel beads to be disposed of defeating the purpose of recycling. Some machines require that a product be introduced to the recycle process to facilitate the final product that the tire was recycled for. Some tires require costly shipping and handling facilities to get the tire to the recycle mechanism.

Tire recycling is a major problem world wide. My invention will help to eliminate this problem in 2 ways:

First by reducing the size of the tire by over 70%, there by reducing the area that it occupies so that the disposable problem will be reduced by that much. This reduction in size should make the tire compactable enough to be discarded in landfills by reducing the size of the area that it will occupy. Also it will be compacted enough so that it will compact in the fill and not “float” to the surface as it now does in landfills.

The second and most important aspect of my invention to recycle the tires is that the Tire Coiling Machine will turn discarded tires into Tire Building Blocks by locking the tire in its coiled up configuration utilizing the Tire Flap Lock. The Tire Flap Lock will hold the tire in its coiled up condition for the life of the tire making it a long lasting and durable product for the construction of homes by turning a discarded tire into a Tire Building Block suited for home building, retaining walls and other construction needs. This Tire Building Block will be held in place for building purposes by using stainless steel ties that have a tensile strength in excess of 300 lbs and are available on the open market, giving the walls built a lifetime in longevity. Because of its inherent flexibility Tire Building Blocks will be ideal for the construction industry, especially in earthquake prone areas as they would absorb the shock waves the same as a tire absorbs bumps and corrugations on a road, saving lives and property.

### DESCRIPTION OF PRIOR ART

| | | |
|---|---|---|
| 2004173699 | Takasaki | 9/2004 |
| JP55005843 | Fujita | 01/1980 |
| 4318825 | Neddenreip | 06/1994 |
| 5890425 | Reinert | 04/1999 |
| 6315223 | Reinert | 11/2001 |
| 6401420 | Darwin | 6/2002 |
| 5237171 | Tosco | 8/1993 |
| 6481650 | Seiichi | 2/2000 |

### BRIEF DESCRIPTION OF THE SEVERAL VIEWS BF THE DRAWING

FIG. 1: Two cuts are made on the tire (100) prior to its being placed in the Tire Bin FIG. 2: (210) for coiling. Cut #1 (110) is placed anywhere on the tire and cuts through the tread, and the sidewall and stops at the beginning of the bead (120). Cut #2 (105) is placed approximately 3 inches away from the first cut (110). This cut will go all the way through the tire, cutting through the bead (120). These two cuts create what is called “The Tire Flap Lock” (115), to be utilized at the final coiling of the tire, to lock the tire in its final coiled up shape.

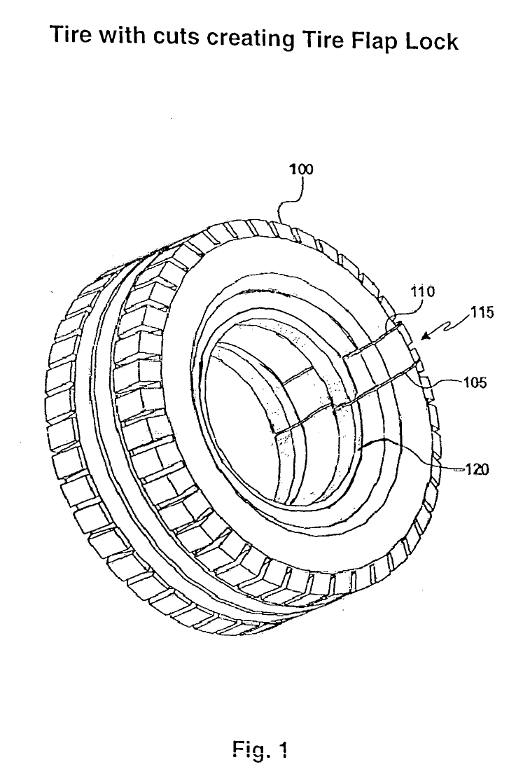

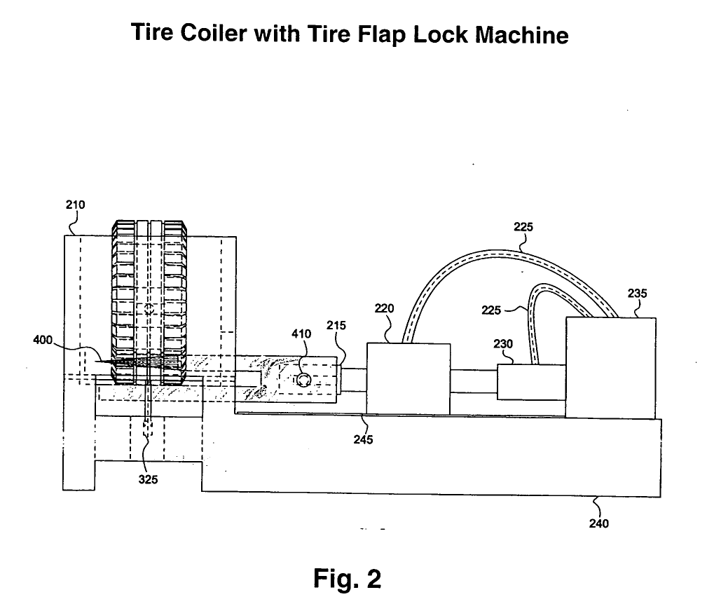

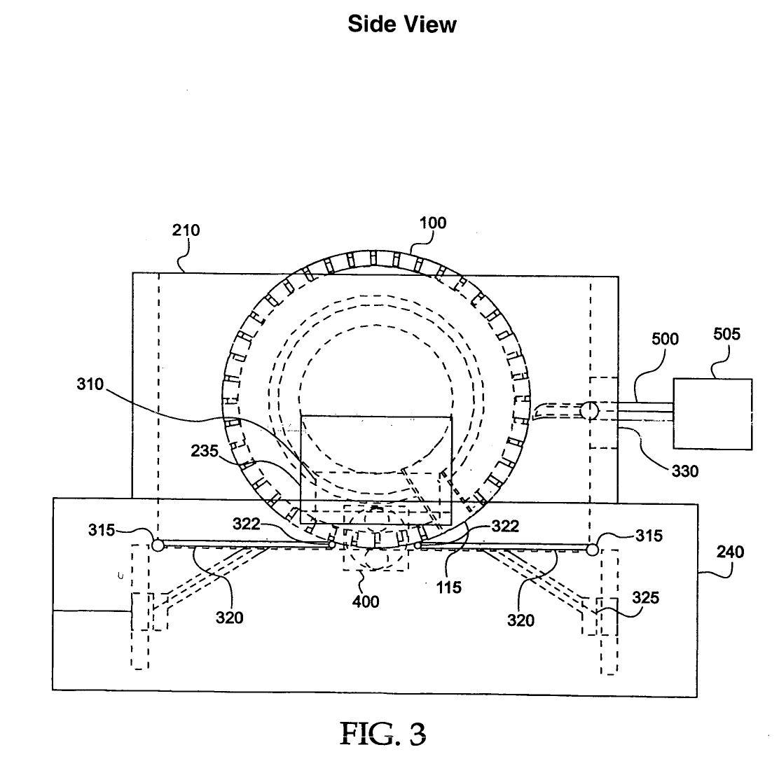

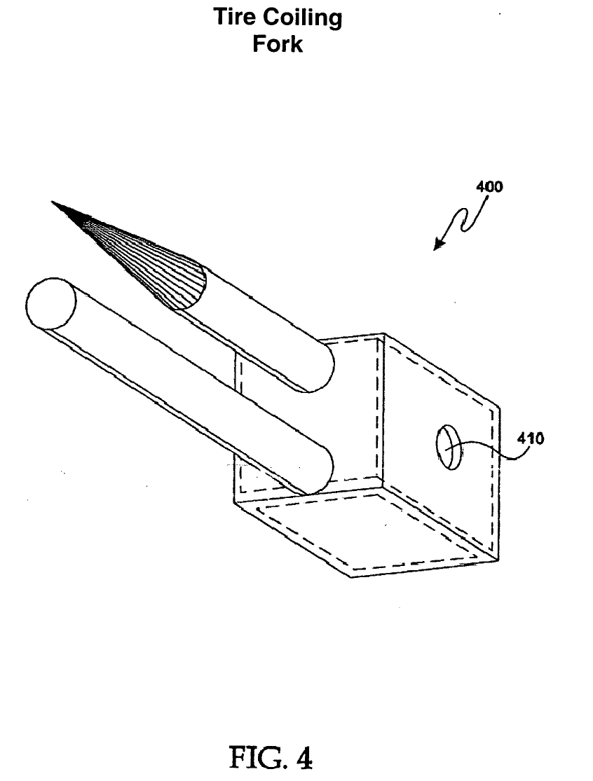

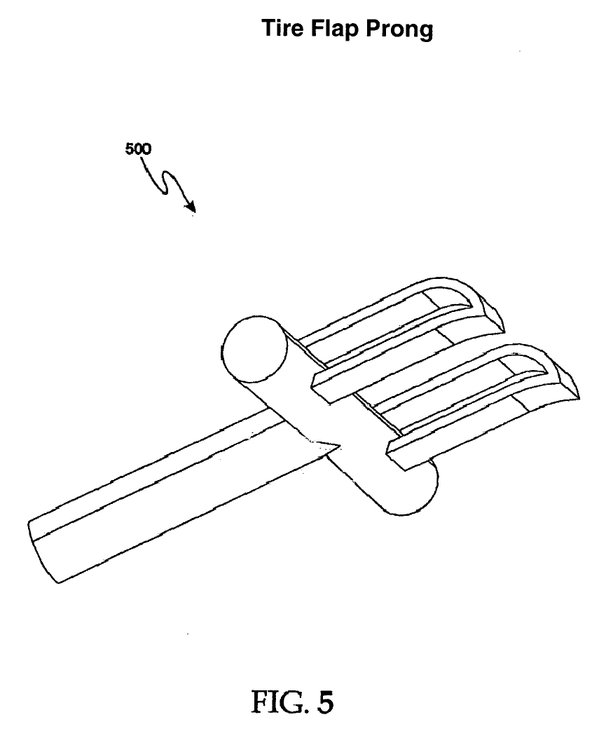

After the cuts are made the tire is put into a specially designed Tire Bin FIG. 2: (210) at which time the Coiling Fork FIG. 4: (400) is pushed into the tire through an access port FIG. 3: (310) or the side of the Tire Bin preparing the tire for coiling. The Tire Coiling Fork FIG. 4: (400) is pushed through the tire by a hydraulic actuator FIG. 2: (230) that is attached to the outer housing of the Hydraulic Motor FIG. 2: (220) which will turn the Tire Coiling Fork in a counter clockwise rotation. The Hydraulic Motor shaft FIG. 2: (215) is attached to the Tire Coiling Fork by a standard pin coupling FIG. 2: (410). This assembly; Hydraulic Motor, pin coupling, and Tire Coiling Fork travel as one unit along the Guide Rails FIG. 2: (245), when the Hydraulic Actuator is activated, which pushes the sharp tine of the Tire Coiling Fork through the tire sidewalls.

The blunt tine on the Tire Coiling Fork will pass along the outside tread of the tire, while the sharp tine penetrates through the sidewalls of the tire, approximately 1 inch above the tread. This sharp tine of the Tire Coiling Fork will travel through the tire and exit out through the opposite sidewall. This will assist in the coiling and keep the tire from slipping out of the Tire Coiling Fork. When this travel and penetration of the tire is complete, the counter clockwise tire coiling will begin by the Hydraulic Motor FIG. 2: (220) powering the Tire Coiling Fork.

As the coiling begins, and the tire coils, there is downward-pressure that will be exerted on the bottom of the Tire Bin by the coiling tire FIG. 3. This downward pressure will be compensated for by the Tire Bin having 2 hinged doors (315) that are spring loaded to exert enough reverse pressure against the tire being coiled, to ensure a tight coil and to compensate for the coiling pressures of the coiling tire. This door mechanism also incorporates a quick release mechanism to release the finished tire from the Tire Bin when the coiling is complete.

As the Tire coiling nears its completion Tire Flap Prongs FIG. 5: (500) will enter the Tire Bin through an access port FIG. 3: (330). As the tire makes its last coil the Tire Flap Prongs will hook the leading edge of the Tire Flap Lock, at cut #1 (110), thereby holding the Tire Flap Lock stationery, while the tire continues the final coil. When the trailing edge of tire cut #1 (110) is opposite the stationery Tire Flap Lock, the coiling will cease. The Coiling Fork will then begin to reverse itself. As it reverses and the tire begins to uncoil the Tire Flap Lock will catch the tire uncoil pressure, locking the tire in the new coiled-up Tire Building Block configuration. The Tire Coiling Fork will stop its reverse motion and be retracted fully from the Tire Bin, leaving the tire in its final coiled up shape and in a locked position created by the Tire Flap Lock. The Tire Flap Prongs FIG. 3: (500) will retract and the bottom doors FIG. 2: (320) will fully release, allowing the coiled tire in its new Tire Building Block shape to drop through and exit the Tire Bin. The doors FIG. 3 (320) will automatically close after the tire has dropped through allowing the cycle to begin again.

### DETAILED DESCRIPTION OF THE INVENTION

Discarded tires are taken to a collection facility where they are processed by my invention, the Tire Coiling with Tire Flap Lock Machine. Two cutters are located near the machine to cut the tire in the required places, creating the Tire Flap Lock. The Tire Coiling with Tire Flap Lock Machine consists of the following, a platform upon which are mounted the Tire Coiling Fork, a special designed Tire Bin to hold the tire in the desired position for coiling, the Tire Coiling Fork and the Tire Flap Prong plus the necessary hydraulic or pneumatic components to operate the same. For the purpose of this patent application we will use hydraulics as the operating and power source to operate the above components.

When the tire approaches the Tire Coiling Machine, 2 cuts are made to create The Tire Flap Lock. Cut #1 is made down through the tread, through the sidewalls and stops at the tire bead. Cut #2 is made about 3 inches along the tire and cuts through the tread, down the sidewalls and through the tire bead cutting the tire in two. These two cuts create The Tire Flap Lock that will be positioned over the tire at its final coiling, to hold the tire in its new coiled up shape as a Tire Building Block.

When these cuts are completed the tire is placed into the Tire Bin that will contain the tire and hold it in the correct position so the rest of the procedure can take place. Once the tire is in the Tire Bin the 2 tined Tire Coiling Fork will be inserted through the Tire Coiling Fork access port. One tine is sharpened to a point while the other is blunt. The sharpened tine will penetrate through the side wall and pass all the way through the casing exiting through the opposite sidewall. The blunt tine will pass along the outside of the tire, along the tread, as the sharp tine penetrates the tire sidewalls. The coiling then takes place with a counter clockwise rotation. As the coiling begins the downward pressure that will be exerted on the bottom of the Tire Bin will be compensated for by the bottom of the Tire Bin having 2 spring loaded doors that will exert reverse pressure against the tire as it coils ensuring a tight coil. When the coiling nears its completion the Tire Flap Prong will enter the Tire Bin through the access port on the Tire Bin, and hook the Tire Flap Lock holding it in the right position so that when the Coiling Fork partially reverses the Tire Flap Lock will engage and absorb the uncoil pressure of the tire, thereby locking the tire in its new coiled up shape known as the Tire Building Block. As this process is completed and both implements, the Tire Coiler Fork and the Tire Flap Prong, are withdrawn from the Tire Bin, the bottom doors will release and the coiled tire, now in its new Tire Building Block form, will drop out. The doors will then close and the process can begin again.

1. What I claim as my invention is a Tire Coiler with Tire Flap Lock Machine that takes a discarded tire and compacts it down to less than 70% of its original size by a coiling process, and locks the tire in that compact size by using the Tire Flap Lock, which was created by making two specifically located cuts on the tire.

2. What I claim as my invention is the Tire Flap Lock as it takes the coiled tire and locks it into its completed recycled shape, preventing the tire from returning to its original un-recycled shape.

3. What I claim as my invention is the Tire Coiling Fork because of its unique design and sole function in the Tire Coiler with Tire Flap Lock Machine to coil a tire into a compact shape by rotation.

4. What I claim as my invention is the Tire Flap Prong as its design and sole purpose is to hook the Tire Flap Lock and hold it in such a manner that when the tire has finished coiling and the Coiling Fork reverses, the Tire Flap Prong will keep the Tire Flap Lock located in position so that when the tire exerts its uncoil pressure the Tire Flap Lock will catch the uncoil pressure of the coiled tire stopping the tire from uncoiling back to its original shape.
